(19) United States
(12) Patent Application Publication
(10) Pub. No.: US 2025/0189007 A1
(43) Pub. Date: Jun. 12, 2025

(54) COMPONENT OF A CAR OR MOTORCYCLE COMPRISING A TITANIA-BASED COATING

(71) Applicant: Brembo S.p.A., Curno, Bergamo (IT)

(72) Inventors: Gianmarco GIORDANO, Curno, Bergamo (IT); Amaia MARTINEZ GOITANDIA, Curno, Bergamo (IT); Haizea ZARRABE, Curno, Bergamo (IT); Estibaliz ARANZABE, Curno, Bergamo (IT); Andrea BONFANTI, Curno, Bergamo (IT); Guido PERRICONE, Curno, Bergamo (IT)

(21) Appl. No.: 18/845,475

(22) PCT Filed: Mar. 9, 2023
(86) PCT No.: PCT/IB2023/052236

§ 371 Date: Sep. 10, 2024

(30) Foreign Application Priority Data
Mar. 11, 2022 (IT) 102022000004739

(51) Int. Cl. F16D 69/02; C23C 18/12

(52) U.S. Cl. CPC F16D 69/027; C23C 18/1216; C23C 18/1241; C23C 18/1254; C23C 18/1295

(57) ABSTRACT

The present invention relates to a component of a car or motorcycle, comprising a metal substrate and a coating for said substrate, wherein said coating comprises TiO₂ and is obtainable by a sol-gel process comprising a step of applying a colloidal solution on the metal substrate of said component of a car or motorcycle, said colloidal solution being obtained from hydrolysis and condensation reactions between an inorganic precursor of TiO₂ and water, said inorganic precursor of TiO₂ having formula Ti(X)₄, wherein the X groups, equal or different from each other, are hydrolysable groups selected from the group consisting of halogens, —OR alkoxy groups and —COOR acyloxy groups, where R is preferably a C₁-C₆ alkyl radical.

### FIELD OF THE INVENTION

The present invention relates to a component of a car or motorcycle, in particular a brake caliper or a brake disc, comprising a metal substrate and a coating for said substrate comprising TiO₂. The present invention further relates to the use of a coating comprising TiO₂ to impart self-cleaning properties to the metal substrate on which it is applied.

### BACKGROUND ART

In the automotive field, the problem of deposition of dust, mud and dirt in general on the metal components of a vehicle, in particular on the metal components of the braking system of a vehicle, such as calipers and brake discs, is strongly felt.

The natural exposure to the environment can affect the appearance of such components. In fact, the accumulation of mud during the use of the vehicle, as well as the deposit of dust during the period in which the vehicle is stopped or parked, compromise the aesthetics of the components themselves. Furthermore, contamination by organic compounds can damage the finish of such components due to phenomena such as sandblasting and decorative oxidation.

The deposit of dirt is not merely an aesthetic matter. The adsorption of water, oxygen or aggressive ions can start the corrosion process, causing damage to the components themselves.

The aforesaid problem is most apparent in luxury and high-performance vehicles, such as high-end cars or racing bikes, for which there is a greater focus on detail and performance.

Therefore, the problem underlying the present invention is to solve the above problem, i.e., to provide coatings for car and motorcycle components, in particular for the components of the braking system of the car and motorcycle, capable of reducing the adhesion of dust, mud and other unwanted elements, keeping said components free from dirt and protecting the surfaces thereof from aggressive cleaning procedures.

### SUMMARY OF THE INVENTION

The above problem is solved by a component of a car or motorcycle, a method for producing said component, as well as the use of a sol-gel coating to impart self-cleaning properties to the metal substrate on which it is applied, as outlined in the appended claims, the definitions of which form an integral part of the present description.

A first object of the present invention is a component of a car or motorcycle, comprising a metal substrate and a coating for said substrate, where said coating comprises TiO₂ and is obtainable by a sol-gel process comprising a step of applying a colloidal solution on the metal substrate of said component of a car or motorcycle,
said colloidal solution being obtained from hydrolysis and condensation reactions between an inorganic precursor of TiO₂ and water,
said inorganic precursor of TiO₂ having formula Ti(X)₄, where the X groups, equal or different from each other, are hydrolysable groups selected from the group consisting of halogens, —OR alkoxy groups and —COOR acyloxy groups, where R is preferably a C₁-C₆ alkyl radical.

A second object of the present invention is a method for producing the aforesaid component of a car or motorcycle, comprising the following steps:
providing a component of a car or motorcycle comprising a metal substrate,
applying a colloidal solution obtained from hydrolysis and condensation reactions between an inorganic precursor of TiO₂ and water on said metal substrate,
said inorganic precursor of TiO₂ having formula Ti(X)₄, where the X groups, equal or different from each other, are hydrolysable groups selected from the group consisting of halogens, —OR alkoxy groups and —COOR acyloxy groups, where R is preferably a C₁-C₆ alkyl radical.

Another object of the present invention is the use of a coating obtainable by the aforesaid method to provide self-cleaning properties to a metal substrate on which it is applied, in particular to a metal substrate of a component of a car or motorcycle, preferably said substrate being made of aluminum or aluminum alloy; or iron or iron alloy, for example steel or cast iron; or titanium or titanium alloy.

A further object of the present invention is the use of a colloidal solution as a coating of a metal substrate, in particular of a component of a car or motorcycle, to provide self-cleaning properties to said coating, in which said colloidal solution is obtained from hydrolysis and condensation reactions between an inorganic precursor of TiO₂ and water,
said inorganic precursor of TiO₂ having formula Ti(X)₄, where the X groups, equal or different from each other, are hydrolysable groups selected from the group consisting of halogens, —OR alkoxy groups and —COOR acyloxy groups, where R is preferably a C₁-C₆ alkyl radical.

The component according to the present invention advantageously exhibits self-cleaning properties.

Further features and advantages of the invention will become apparent from the description of some embodiments, given below by way of non-limiting indication.

### BRIEF DESCRIPTION OF THE DRAWINGS

FIG. 1 shows photographs of an AlSi7 alloy substrate on which a coating comprising TiO₂ according to the present invention is applied, before (A) and after (B) being subjected to the adhesion test according to the standard ASTM D3359.

FIG. 2 is a graph showing the UV-Vis light degradation rate of methylene blue dye on an AlSi7 alloy substrate coated with TiO₂ in accordance with the present invention compared to the UV-Vis light degradation rate of methylene blue dye on an uncoated AlSi7 alloy substrate.

### DETAILED DESCRIPTION OF THE INVENTION

The present invention relates to a component of a car or motorcycle comprising a metal substrate and a coating for said substrate comprising TiO₂, in which said coating is obtained with a sol-gel process from an inorganic precursor of TiO₂. More in particular, said process comprises a step of applying a colloidal solution obtained from hydrolysis and condensation reactions between an inorganic precursor of TiO₂ and water on said metal substrate.

It has been observed that the component in accordance with the present invention possesses self-cleaning properties, showing a photocatalytic activity against organic dirt and a greater repellency against sand and mud, which adhere with more difficulty on the coated metal substrate of the component.

In addition, the aforesaid coating surprisingly exhibited a high adhesion to the metal substrate on which it was applied. Said coating also showed a high level of transparency, without entailing significant alterations in the color of the substrate on which it was applied, an effect which is absolutely not negligible in the automotive field.

The sol-gel process includes the synthesis of a colloidal solution, referred to as sol, which forms the precursor for the subsequent formation of an inorganic lattice, referred to as a gel, through hydrolysis and condensation reactions.

The term “colloidal solution” used in the present application denotes the product obtained from the hydrolysis and condensation reactions occurring between the aforesaid inorganic precursor of TiO₂ and water.

Said inorganic precursor of TiO₂ has formula Ti(X)₄, where the X groups, which can be equal or different from each other, are hydrolysable groups selected from the group consisting of —OR alkoxy groups, —COOR acyloxy groups and halogens. Preferably, R is a C₁-C₆ alkyl radical and the halogens are preferably Cl, Br and I.

Preferably, the X groups are —OR alkoxy groups, where R is selected from the group consisting of methyl, ethyl, propyl, and butyl. More preferably, the X groups are —OR alkoxy groups, where R is selected from isopropyl and n-butyl.

Preferably, the inorganic precursor of TiO₂ is titanium tetra-alkoxide (also referred to as tetra-alkyl titanate), preferably having the four alkoxy groups equal to each other. Preferably, the inorganic precursor of TiO₂ is titanium n-butoxide (TNBT) or titanium isopropoxide (TTIP).

In accordance with different embodiments, the colloidal solution can be obtained by reacting said inorganic precursor of TiO₂ and water in the presence of a catalyst of the hydrolysis or condensation reactions or in the presence of a chelating agent. The colloidal solution obtained using said catalyst is referred to below as “Colloidal solution No. 1”; the colloidal solution obtained using said chelating agent is referred to below as “Colloidal solution No. 2”.

Colloidal solution No. 1

In accordance with a first embodiment of the present invention, said colloidal solution is obtained by mixing:
said at least one inorganic precursor of TiO₂;
at least one C₁-C₄ alcohol;
water;
a catalyst of the hydrolysis and condensation reactions.

The aforesaid components are mixed so that said inorganic precursor of TiO₂ and water react in the presence of a C₁-C₄ alcohol (forming the reaction solvent) and a catalyst, to give the aforesaid colloidal solution.

Preferably, said C₁-C₄ alcohol is selected from methanol, ethanol, isopropanol, isobutanol, n-butanol and mixtures thereof. Preferably, said alcohol is ethanol.

Preferably, the C₁-C₄ alcohol is present in an amount by weight between 40 and 90%, more preferably between 50 and 80%, with respect to the total weight of the components subjected to the sol-gel process.

Preferably, the water is present in an amount by weight between 1 and 20%, more preferably between 1 and 10%, with respect to the total weight of the components subjected to the sol-gel process.

Preferably, said catalyst is an inorganic acid catalyst selected from the group consisting of HNO₃, HCl and H₂SO₄, or an organic acid catalyst, for example acetic acid. More preferably, said catalyst is an inorganic acid catalyst, even more preferably HNO₃. Preferably, said acid catalyst is added in an amount such as to obtain a pH between 2 and 3.5, or between 2 and 3, preferably a pH of about 2.

Preferably, the molar ratio between said inorganic precursor of TiO₂, said C₁-C₄ alcohol, water and said catalyst is 1:20-60:1-5:0.01-0.1, more preferably it is 1:40-60:2-3:0.02-0.05.

In accordance with a preferred embodiment, said colloidal solution is obtained by mixing titanium n-butoxide (TNBT), ethanol, water and HNO₃, preferably in a molar ratio TNBT/ethanol/water/HNO₃ equal to 1:50:2:0.04.

Preferably, said colloidal solution is obtained by mixing the aforesaid components (i.e., inorganic precursor of TiO₂, C₁-C₄ alcohol, water and catalyst) at a temperature of at least 10° C. and not higher than 50° C., preferably at room temperature. The term “room temperature” denotes a temperature between 18 and 25° C.

Preferably, said step of mixing the aforesaid components is conducted for a period of at least 15 hours, or at least 16 hours, or at least 17 hours, or at least 18 hours.

Preferably, said step of mixing the aforesaid components is conducted for a period of time between 18 hours and 24 hours, more preferably between 20 and 24 hours, even more preferably of about 20 hours.

According to a preferred embodiment, the sol-gel process for obtaining said coating further comprises a heat treatment step after said step of applying the colloidal solution.

Preferably, said heat treatment step is carried out at a temperature of at least 350° C., preferably between 35° and 500° C., more preferably of about 400° C.

Preferably, said heat treatment step is carried out for a time between about 30 and 180 minutes, preferably of about one hour.

Without being constrained by theory, said drying and solidification heat treatment step allows to eliminate the liquid phase from the gel, further promoting the condensation phase.

Colloidal solution No. 2

In accordance with a second embodiment of the present invention, said colloidal solution is obtained by mixing:
said at least one inorganic precursor of TiO₂;
at least one C₁-C₄ alcohol;
water;
a chelating agent, preferably acetylacetone.

The aforesaid components are mixed so that said inorganic precursor of TiO₂ and water react in the presence of a C₁-C₄ alcohol (forming the reaction solvent) and a chelating agent, to give the aforesaid colloidal solution.

Preferably, said C₁-C₄ alcohol is selected from methanol, ethanol, isopropanol, isobutanol, n-butanol and mixtures thereof. Preferably, said alcohol is ethanol.

Preferably, said at least one inorganic precursor of TiO₂ is present in an amount by weight between 4 and 35% by weight, with respect to the total weight of the components subjected to the sol-gel process.

Preferably, the C₁-C₄ alcohol is present in an amount by weight between 30 and 70%, with respect to the total weight of the components subjected to the sol-gel process.

Preferably, the water is present in an amount by weight between 1 and 55%, with respect to the total weight of the components subjected to the sol-gel process.

Preferably, said chelating agent is present in an amount by weight between 1 and 10%, with respect to the total weight of the components subjected to the sol-gel process.

In accordance with an embodiment of the invention, said colloidal solution is obtained by mixing titanium isopropoxide (TTIP) in an amount between 5 and 10% by weight, preferably of about 6% by weight; ethanol in an amount between 40 and 50% by weight, preferably of about 41% by weight; water in an amount between 50 and 60% by weight, preferably of about 51% by weight; and acetylacetone in an amount between 2 and 5% by weight, preferably of about 2% by weight.

In accordance with another embodiment of the invention, said colloidal solution is obtained by mixing titanium isopropoxide (TTIP) in an amount between 25 and 30% by weight, preferably of about 30% by weight; ethanol in an amount between 60 and 70% by weight, preferably of about 65% by weight; water in an amount between 1 and 5% by weight, preferably of about 1.5% by weight; and acetylacetone in an amount between 7 and 10% by weight, preferably of about 9% by weight.

Preferably, the process for obtaining the aforesaid colloidal solution comprises a first step of mixing the inorganic precursor of TiO₂ with the C₁-C₄ alcohol; a subsequent step of adding the chelating agent and stirring the resulting solution for a time between about 10 and 60 minutes, preferably of about 30 minutes; and a further step of adding the water, preferably dropwise, and stirring the resulting solution for a time between about 30 and 90 minutes, preferably for about one hour, at room temperature. The term “room temperature” denotes a temperature between 18 and 25° C.

In accordance with an embodiment, the process for obtaining said coating by applying Colloidal solution No. 2 does not comprise a heat treatment step after the step of applying the colloidal solution, contrary to the process for obtaining said coating by applying Colloidal solution No. 1.

The description below relates to both the process for obtaining the coating comprising TiO₂ using Colloidal solution No. 1 and the process for obtaining the coating comprising TiO₂ using Colloidal solution No. 2.

The step of applying the aforesaid colloidal solution on the metal substrate of the component according to the present invention can be carried out employing various technologies selected among spray coating, dip coating, spin coating and electrodeposition.

In accordance with a preferred embodiment, said step of applying the colloidal solution on the metal substrate of the component according to the present invention is carried out by dip-coating. In accordance with this embodiment, the metal substrate is immersed in the colloidal solution and extracted at a constant rate to allow the evaporation of the solvent and allow the gelation thereof.

The withdrawal speed of the metal substrate from the above colloidal solution determines the thickness of the resulting coating. Preferably, the withdrawal speed of the metal substrate from the aforesaid colloidal solution is at least 100 mm/min, or at least 150 mm/min, or at least 200 mm/min, or at least 250 mm/min. More preferably, the withdrawal speed of the metal substrate from the aforesaid colloidal solution is greater than 250 mm/min, still more preferably between 300 mm/min and 1000 mm/min, for example about 500 mm/min.

Preferably, said coating has a thickness of at least 50 nanometers. More preferably, said coating comprising TiO₂ has a thickness between 1 micron and 5 microns, even more preferably greater than 1 micron.

In accordance with an embodiment, said metal substrate is aluminum or aluminum alloy, for example AlSix alloy, where x=5, 7, 9, 10, 11.

In accordance with another embodiment, said metal substrate is iron or iron alloy, for example steel or cast iron.

In accordance with a further embodiment, said metal substrate is titanium or titanium alloy.

Optionally, said metal substrate is treated with a specific treatment, for example anodization.

In a preferred embodiment of the invention, said component is the brake caliper of the braking system of a car or motorcycle, or a part of said brake caliper.

In another embodiment, said component is the disc of the braking system of a car or motorcycle, or a part of said disc. For example, said component is the bell of said disc.

### EXPERIMENTAL SECTION

A colloidal solution was prepared as follows. Titanium n-butoxide (TNBT) was dissolved in ethanol; then nitric acid and water were added dropwise to the solution containing TNBT and ethanol, kept under continuous stirring; the resulting solution was stirred for 20 hours at room temperature. The molar ratio of TNBT, ethanol, water and nitric acid employed is 1:50:2:0.04.

Said solution was applied to an AlSi7 alloy substrate, for example of a brake caliper, by dip coating using a withdrawal speed of 500 mm/min.

The brake caliper comprising the substrate thus coated was then subjected to a heat treatment at 400° C. for 1 hour, obtaining a coating comprising TiO₂ with anatase crystallographic phase.

The brake caliper obtained with the aforesaid process was subjected to the following tests.

### 1) Adhesion Test

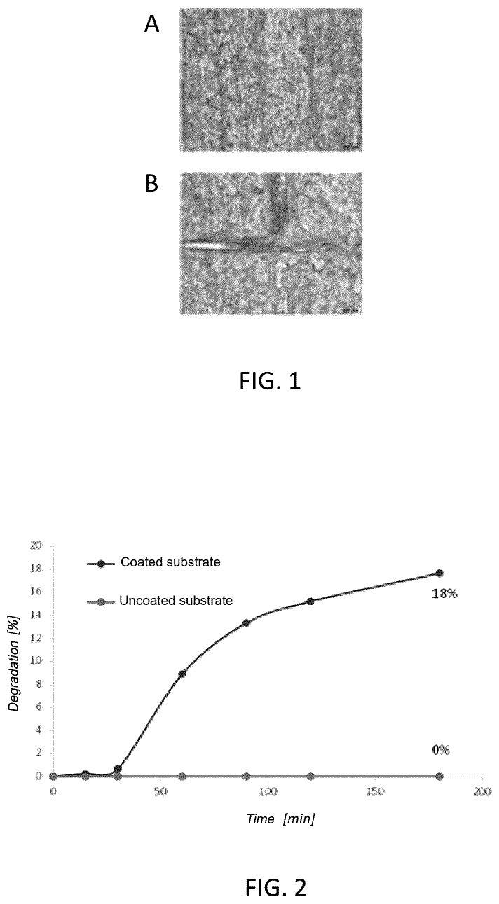

The cross-cut test and tape test were executed in accordance with ASTM D3359 to determine the adhesion of the coating to the substrate. As apparent from the optical microscope photographs shown in FIG. 1, the coating remained intact, thus passing the adhesion test.

### 2) Transparency

The transparency of the coating deposited on the substrate was validated by CIELAB or l*a*b colorimetric analysis so as to verify the color difference between the coated substrate in accordance with the present invention and the corresponding uncoated substrate. The aforesaid test yielded a value ΔE=3, indicating that the color did not undergo a significant change with respect to the uncoated substrate. The transparency level obtained is to be considered acceptable for applications in the automotive field.

### 3) Contact Angle

The measurement of the static contact angle was performed, in accordance with the standard UNI-828-2013, to identify the wettability behavior of the coating as deposited on the AlSi7 alloy substrate.

A contact angle <10° was measured, i.e., 83° less with respect to the corresponding uncoated substrate. This demonstrates the superhydrophilic behavior of the coated substrate in accordance with the present invention and thus the excellent antifouling properties thereof.

### 4) Photocatalytic Activity

The photocatalytic activity was evaluated by monitoring the degradation, under UV irradiation, of an organic dye (methylene blue) on the coated substrate in accordance with the present invention and on the corresponding uncoated substrate. In particular, the photocatalytic performance was evaluated by monitoring the temporal evolution of the concentration of the aforesaid organic dye, by means of a UV-Vis spectrophotometer.

It was observed that the dye does not degrade in the absence of lighting and photocatalyst, demonstrating that no adsorption phenomena occur on the surface of the substrates.

The stability of the organic dye (methylene blue) to UV light was also studied, so as to be able to exclude the influence of the dye photolysis phenomenon on the photocatalytic activity results. In particular, a solution of 16.5 μM methylene blue was irradiated with UV fluorescence lamps (6 W, 800 uW/cm²) with maximum emission at 365 nm, placed 1 cm from the sample; the irradiation time was extended for 2 hours, measuring aliquots every 15 minutes. It was seen that the concentration of the dye decreased by only 2% after 2 hours of irradiation.

To study the photocatalytic activity of the TiO₂-based coating on the AlSi7 alloy substrate, an initial solution of 16.5 μM methylene blue in which the coated sample was dipped was prepared. The reaction medium was irradiated with two UV fluorescence lamps (6 W, 800 uW/cm2) with a maximum emission of 365 nm, placed 1 cm from the sample. The photocatalytic process was monitored by following the decrease of the absorbance intensity of the dye at 662 nm with respect to the irradiation time. The irradiation time was extended for 2 hours, measuring aliquots every 15 minutes with the UV-Vis spectrophotometer. The results obtained are shown in the graph in FIG. 2, which shows the temporal evolution of the degradation of the methylene blue dye on the coated substrate compared to the temporal evolution of the degradation of the same dye on the uncoated substrate. The temporal evolution course of degradation is expressed as % degradation over time or degradation rate. It should be noted that on the uncoated substrate there is no degradation of the aforementioned dye, while on the coated substrate according to the present invention the % degradation is 18%, demonstrating the photocatalytic activity of the TiO₂-based coating.

### 5) Sand Adhesion Test

A protocol has been developed to quantify the self-cleaning quality of the TiO₂-based coating, in particular to quantify the adhesion of sand to the coated substrate in accordance with the present invention and to the corresponding uncoated reference substrate.

Particles of sand were dropped through a funnel on the aforesaid substrates. The distance between the funnel and the substrates is 15 cm, while the amount of sand falling on the substrates is 25 grams.

The size distribution of the sand used for this test is less than 250 microns.

To perform the aforesaid test, two inclined planes were used, in this case a plane with an inclination of 200 and a plane with an inclination of 40°.

The amount of sand remaining attached to the substrates was determined by the weight differences of the substrates before and after the test. In particular, having set the % fouling rate of the uncoated substrate to 100, the proportion was made to determine the % fouling rate of the coated substrate.

The results obtained using the 20° inclined plane are shown in Table 1 below, while the results obtained using the 40° inclined plane are shown in Table 2 below.

TABLE 1
20° inclined plane

| | Weight | | % fouling |
|---|---|---|---|
| | before test | Weight after | rate by |
| | (g) | test (g) | weight |
| Reference | 84.57 | 84.5766 | 100 |
| substrate | | | |
| Coated | 82.2245 | 82.228 | 53.0303030 |
| substrate | | | |

TABLE 2
40° inclined plane

| | | | % fouling |
|---|---|---|---|
| | Weight before | Weight after | rate by |
| | test (g) | test (g) | weight |
| Reference | 84.57 | 84.5945 | 100 |
| substrate | | | |
| Coated | 82.2242 | 82.2278 | 12.3265306 |
| substrate | | | |

As can be seen from the results reported in the above tables, the adhesion of the sand is higher on the uncoated reference substrate (100% fouling rate by weight), while the coated substrate according to the invention is less fouled.

From the above results, it can further be seen that the adhesion of the sand decreases with the increase of the inclination of the plane (53.0303030% fouling rate by weight for the 200 inclined plane and 12.3265306% fouling rate by weight for the 40° inclined plane).

### 6) Mud Adhesion Test

The mud adhesion test was performed following the same protocol as the sand adhesion test, i.e., by dropping drops of mud (i.e., drops of water mixed with sand) on the coated substrate in accordance with the invention and on the corresponding uncoated substrate.

The same behavior was found, i.e., a lower adhesion of the mud drops on the coated substrate in accordance with the present invention.

It is apparent that those described are only particular embodiments of the present invention. Those skilled in the art will be able to make all the necessary modifications to the component and method of the present invention for adapting them to particular conditions, without however departing from the scope of protection as defined in the appended claims.

1-26. (canceled)

27. A component of a car or motorcycle, comprising a metal substrate and a coating for said substrate, wherein said coating comprises TiO₂ and is obtainable by a sol-gel process comprising a step of applying a colloidal solution on the metal substrate of said component of a car or motorcycle,
said colloidal solution being obtained from hydrolysis and condensation reactions between an inorganic precursor of TiO₂ and water,
said inorganic precursor of TiO₂ having formula Ti(X)₄, where the X groups, equal or different from each other, are hydrolysable groups selected from the group consisting of halogens, —OR alkoxy groups and —COOR acyloxy groups.

28. The component according to claim 27, wherein said inorganic precursor of TiO₂ is titanium n-butoxide (TNBT) or titanium isopropoxide (TTIP).

29. The component according to claim 27, wherein said colloidal solution is obtained by mixing:
said at least one inorganic precursor of TiO₂;
at least one C₁-C₄ alcohol;
water;
a catalyst of the hydrolysis and condensation reactions, said catalyst being an inorganic acid catalyst selected from the group consisting of HNO₃, HCl and H₂SO₄.

30. The component according to claim 29, wherein the molar ratio between said inorganic precursor of TiO₂, said C₁-C₄ alcohol, water and said inorganic acid catalyst is 1:20-60:1-5:0.01-0.1.

31. The component according to claim 29, wherein said colloidal solution is obtained by mixing TNBT, ethanol, water and HNO₃.

32. The component according to claim 29, wherein said coating is obtainable by a process further comprising a step of heat treatment subsequent to said step of applying the colloidal solution.

33. The component according to claim 32, wherein said step of heat treatment is carried out at a temperature of at least 350° C.

34. The component according to claim 27, wherein said colloidal solution is obtained by mixing:
said at least one inorganic precursor of TiO₂;
at least one C₁-C₄ alcohol;
water;
a chelating agent.

35. The component according to claim 34, wherein said colloidal solution is obtained by mixing:
said at least one inorganic precursor of TiO₂ in an amount between 4 and 35% by weight,
said at least one C₁-C₄ alcohol in an amount between 30 and 70% by weight;
water in an amount between 1 and 55% by weight;
said chelating agent in an amount between 1 and 10% by weight,
said percentage amounts being with respect to the total weight of the components subjected to the sol-gel process.

36. The component according to claim 34, wherein said colloidal solution is obtained by mixing TTIP between 5 and 10% by weight, ethanol between 40 and 50% by weight, water between 50 and 60% by weight, acetylacetone between 2 and 5% by weight.

37. The component according to claim 34, wherein said colloidal solution is obtained by mixing TTIP between 25 and 30% by weight, ethanol between 60 and 70% by weight, water between 1 and 5% by weight, acetylacetone between 7 and 10% by weight.

38. The component according to claim 27, wherein the step of applying the colloidal solution on the metal substrate is carried out by dip-coating of the metal substrate into the colloidal solution.

39. The component according to claim 38, wherein the withdrawal speed of the metal substrate from said colloidal solution is higher than 250 mm/min.

40. The component according to claim 27, wherein said coating has a thickness between 1 micron and 5 microns.

41. The component according to claim 27, wherein said substrate is made of aluminum or aluminum alloy; or iron or iron alloy; or titanium or titanium alloy.

42. The component according to claim 27, said component being the brake caliper of the braking system of a car or motorcycle, or a part thereof, or
said component being the brake disc of the braking system of a car or motorcycle, or a part thereof.

43. A method for producing the component of a car or motorcycle according to claim 27, comprising the following steps:
providing a component of a car or motorcycle comprising a metal substrate,
applying a colloidal solution obtained from hydrolysis and condensation reactions between an inorganic precursor of TiO₂ and water on said metal substrate,
said inorganic precursor of TiO₂ having formula Ti(X)₄, where the X groups, equal or different from each other, are hydrolysable groups selected from the group consisting of halogens, —OR alkoxy groups and —COOR acyloxy groups.

44. The method according to claim 43, wherein said colloidal solution is applied on said metal substrate by dip-coating of the metal substrate into said colloidal solution.

45. Use of a colloidal solution as a coating of a metal substrate, in particular of a metal substrate of a component of a car or motorcycle, to provide self-cleaning properties to said coating,
said colloidal solution being obtained from hydrolysis and condensation reactions between an inorganic precursor of TiO₂ and water,
said inorganic precursor of TiO₂ having formula Ti(X)₄, where the X groups, equal or different from each other, are hydrolysable groups selected from the group consisting of halogens, —OR alkoxy groups and —COOR acyloxy groups.

46. The use according to claim 45, wherein said colloidal solution is obtained by mixing:
said at least one inorganic precursor of TiO₂;
at least one C₁-C₄ alcohol;
water;
a catalyst of the hydrolysis and condensation reactions, said catalyst being an inorganic acid catalyst selected from the group consisting of HNO₃, HCl and H₂SO₄.

47. The use according to claim 46, wherein the molar ratio between said inorganic precursor of TiO₂, said C₁-C₄ alcohol, water and said inorganic acid catalyst is 1:20-60:1-5:0.01-0.1.

48. The use according to claim 46, wherein said colloidal solution is obtained by mixing TNBT, ethanol, water and HNO₃.

49. The use according to claim 45, wherein said colloidal solution is obtained by mixing:
said at least one inorganic precursor of TiO₂;
at least one C₁-C₄ alcohol;
water;
a chelating agent.

50. The use according to claim 49, wherein said colloidal solution is obtained by mixing:
said at least one inorganic precursor of TiO₂ in an amount between 4 and 35% by weight,
said at least one C₁-C₄ alcohol in an amount between 30 and 70% by weight;
water in an amount between 1 and 55% by weight;
said chelating agent in an amount between 1 and 10% by weight,
said percentage amounts being with respect to the total weight of the components subjected to the sol-gel process.

51. The component according to claim 29, wherein said at least one C₁-C₄ alcohol is ethanol.

52. The component according to claim 34, wherein said at least one C₁-C₄ alcohol is ethanol and said chelating agent is acetylacetone.

53. The component according to claim 43, wherein R is a C₁-C₆ alkyl radical, and said metal substrate is made of aluminum or aluminum alloy; or iron or iron alloy; or titanium or titanium alloy.

54. The component according to claim 44, wherein the withdrawal speed of the metal substrate from said colloidal solution is higher than 250 mm/min.

55. The use according to claim 45, wherein said inorganic precursor of TiO₂ being titanium n-butoxide (TNBT) or titanium isopropoxide (TTIP).

56. The use according to claim 46, wherein said at least one C₁-C₄ alcohol is ethanol.

57. The use according to claim 49, wherein said at least one C₁-C₄ alcohol is ethanol, and said chelating agent is acetylacetone.
